(19) United States
(12) Patent Application Publication
(10) Pub. No.: US 2013/0252167 A1
(43) Pub. Date: Sep. 26, 2013

(54) TONER

(71) Applicants: Shuhei Moribe, Mishima-shi (JP); Katsuhisa Yamazaki, Numazu-shi (JP); Daisuke Yoshiba, Suntou-gun (JP); Toru Takahashi, Abiko-shi (JP); Daisuke Tsujimoto, Toride-shi (JP); Masami Fujimoto, Suntou-gun (JP)

(72) Inventors: Shuhei Moribe, Mishima-shi (JP); Katsuhisa Yamazaki, Numazu-shi (JP); Daisuke Yoshiba, Suntou-gun (JP); Toru Takahashi, Abiko-shi (JP); Daisuke Tsujimoto, Toride-shi (JP); Masami Fujimoto, Suntou-gun (JP)

(73) Assignee: CANON KABUSHIKI KAISHA, Tokyo (JP)

(21) Appl. No.: 13/991,348

(22) PCT Filed: Dec. 13, 2011
(86) PCT No.: PCT/JP2011/079279

§ 371 Date: Jun. 3, 2013

(30) Foreign Application Priority Data
Dec. 28, 2010 (JP) 2010-291641

(51) Int. Cl. G03G 9/087

(52) U.S. Cl. CPC G03G 9/08755
USPC 430/109.4; 430/109.1

(57) ABSTRACT

A toner comprising toner particles, each of which contains a binder resin and a colorant, wherein the binder resin includes a resin having an endothermic peak at a temperature of 55° C. to 120° C. in a DSC curve; the toner has a softening point Tm of 90° C. to 140° C.; in the viscoelastic characteristic of the toner measured at a frequency of 6.28 rad/sec, the storage elastic modulus at a temperature of 180° C. is 1.0×10² Pa to 1.0×10⁴ Pa; in a chart with the temperature on the x-axis and tan δ on the y-axis, tan δ has a peak having a peak top in the range of 50° C. to 70° C.; tan δ (P) at the peak top temperature is 2.0 to 10.0; the ratio of the tan δ (P) at the peak top temperature to tan δ (Tm) at a temperature of Tm (tan δ (P)/tan δ (Tm)) is in the range of 2.5 to 8.0.

### TECHNICAL FIELD

The present invention relates to a toner used for an image forming method using electrophotography, electrostatic recording, or toner jet recording.

### BACKGROUND ART

Recently, users more often have had opportunities to output image data taken in by digital cameras, digital video cameras, and mobile terminals and graphic images such as posters using an image forming apparatus such as digital copiers and digital LBPs.

In the case where an image is output onto a high gloss paper such as coated papers and art papers used in this application, if the gloss of the image is smaller than the gloss of the paper, the image gives a dark impression and the quality and texture of the image are impaired. Accordingly, an image with high gloss needs to be formed for this application.

In the graphic image, images having a graph portion and a letter portion mixed and having different amounts of the toner to be disposed are often output. In such an image, an image having no gloss difference and having reproducibility of gradation needs to be output.

In the case where only the image with high gloss is simply pursued, reduction in viscosity of the toner is effective. On the other hand, off-set resistance at a high temperature is deteriorated. Particularly, in the case of graphic application, papers having various sizes ranging from small sizes such as a postcard size or an L size of photos to an A3 size are continuously fed in many cases. In this case, if a large size paper such as an A3 paper is fed immediately after a small size paper is continuously output, both ends of the A3 paper are fixed by a heating roller whose ends are overheated, and high temperature off-set is undesirably produced in the ends of the paper (hereinafter, this phenomenon is referred to as “end off-set”).

Then, a variety of toners has been proposed in order to satisfy both high gloss properties and off-set resistance at a high temperature.

PTL 1 proposes a method in which an aluminum element and a tin element are contained in a crystalline polyester resin and a non-crystalline polyester resin to control a degree of cross-linking between the resins; thereby, higher gloss can be obtained and the high temperature off-set phenomenon can be prevented. In the case where a fixing aid such as a crystalline polyester is added, however, a difference in a melting speed is produced between the crystalline component and other resin component, resulting in uneven gloss. This may be a problem particularly in the graphic application in which the quality and texture of the image are important, and there is plenty of room for improvement.

PTL 2 proposes a polyester resin obtained by copolymerization of a non-crystalline block component with a crystalline block component having a different softening point from that of the non-crystalline block component. In this proposal, the crystalline polyester block is copolymerized with the non-crystalline polyester block. Accordingly, the resin is partially made compatible. As a result, a more viscous portion and a less viscous portion are produced in the toner to produce uneven viscosity of the toner, leading to uneven gloss of the image.

PTL 3 proposes improvement of the uneven gloss by using three binder resins having different crystalline states. This is effective as a method for providing higher gloss and improving the uneven gloss, but leaves much to be improved in terms of the high temperature off-set, particularly the end off-set.

As described above, there are many technical problems in preventing the end off-set while higher gloss and uniformity of gloss are achieved, and there is room for improvement.

### CITATION LIST

### Patent Literature

PTL 1: Japanese Patent Application Laid-Open No. 2009-122522
PTL 2: Japanese Patent Application Laid-Open No. 2005-062509
PTL 3: Japanese Patent Application Laid-Open No. 2008-165017

### SUMMARY OF INVENTION

### Technical Problem

An object of the present invention is to provide a toner in which the above problems are solved. Namely, an object of the present invention is to provide a toner that offers high and uniform gloss, and can prevent the end off-set.

### Solution to Problem

The present invention relates to a toner comprising toner particles each of which contains a binder resin and a colorant, wherein the binder resin includes a resin having an endothermic peak at a temperature of not less than 55° C. but not more than 120° C. in a DSC curve measured by a differential scanning calorimeter, the toner has a softening point Tm of not less than 90° C. but not more than 140° C., in the viscoelastic characteristic of the toner measured at a frequency of 6.28 rad/sec,

i) a storage elastic modulus at a temperature of 180° C. (G′180) is not less than 1.0×10² Pa but not more than 1.0×10⁴ Pa,
ii) in a chart with a temperature on an x-axis and a loss tangent tan δ on a y-axis,
a) tan δ has at least one peak having a peak top in the range of not less than 50° C. but not more than 70° C.,
b) tan δ (P) is not less than 2.0 but not more than 10.0 wherein a loss tangent at a peak top temperature that gives the peak top of the peak is tan δ (P), and
c) a ratio of tan δ (P) to tan δ (Tm) (tan δ (P)/tan δ (Tm)) is in the range of not less than 2.5 but not more than 8.0 wherein a loss tangent at a softening point Tm of the toner is tan δ (Tm).

### Advantageous Effects of Invention

The storage elastic modulus of a toner including a binder resin having an endothermic peak in a specific region of temperature is controlled within a predetermined range, and tan δ at a specific temperature of the toner is controlled. Thereby, high and uniform gloss can be achieved. Further, the end off-set can be prevented.

### BRIEF DESCRIPTION OF DRAWINGS

FIG. 1 is a schematic view of a flow curve of a toner according to the present invention measured by Flowtester.

### DESCRIPTION OF EMBODIMENTS

Usually, in order to achieve high gloss, it is known that the melt viscosity of a binder resin as a principal component of the toner is designed to be low. If the melt viscosity of the binder resin itself designed to be low, however, the influence on the off-set resistance at a high temperature is very large.

Then, a variety of methods has been examined in which a fixing aid (an additive such as a low melting point wax and a crystalline polyester) is used to control the melting properties of the binder resin are controlled by the plastic effect, thereby achieving higher gloss and off-set resistance at a high temperature at the same time.

Control of the plastic effect by adding other substance, however, causes a problem, i.e., compatibility with the binder resin. Namely, the viscosity is reduced in only part of the binder resin made compatible to produce a difference in the melting speed between portions having reduced viscosity and other portions. The difference leads to the uneven gloss and the high temperature off-set. Particularly, in the image such as graphic images in which gradation is important, the difference in the melting speed easily leads to the uneven gloss.

Usually, a solid image having a large amount of the toner to be disposed has thermal conductivity inferior to that of a halftone image having a small amount of the toner to be disposed. Accordingly, in the case where the solid image is molten by the above method at the time of fixing, only part of the binder resin made compatible is molten, and the viscosity of the whole resin cannot be reduced instantly. As a result, while the halftone image having a small amount of the toner to be disposed obtains high gloss to some extent, the solid image cannot achieve high gloss because melting cannot be sufficiently performed. This leads to the uneven gloss within the image.

Then, the present inventors found out that the above problems can be solved by providing a point at which the melting properties change within the same molecule of the binder resin, instead of simply adding a component giving the plastic effect.

Namely, the feature of the present invention is to design a crystalline state or a state close to crystal obtained by partial orientation of the molecular chain within the binder resin. This oriented molecule portion has a crystalline state or a state close to crystal. For this reason, when the temperature reaches a fixing temperature region, the binder resin in the toner starts to melt from the oriented molecule portion. As a result, the melting speed of the whole toner is accelerated, and the viscosity is instantly reduced mainly at the oriented molecule portion, enabling higher gloss.

In the case of addition of a crystalline resin, the melting speed is accelerated only in very small portions around the crystalline resin. Compared to this, in the present invention, because the oriented molecule portion exists within the binder resin, the melt viscosity is reduced in all the resin around the binder resin. As a result, the viscosity is instantly reduced in the whole resin, thereby achieving higher gloss. Moreover, the melting speed of the whole resin is high and uniform. For this, irrespective of the amount of the toner to be disposed, a uniform melting state can be produced. As a result, even in an image having different gradation, uniform gloss can be obtained.

The binder resin in the present invention has an endothermic peak at a temperature of not less than 55° C. but not more than 120° C., and more preferably not less than 80° C. but not more than 110° C. in a DSC curve of the binder resin measured by a differential scanning calorimeter.

The peak temperature shows that the binder resin in the toner starts to melt from the temperature. Accordingly, if the endothermic peak is lower than 55° C., melting of the oriented molecule portion is drastically reduced immediately after the paper enters a fixing unit. As a result, the difference between the melting speed of the polymer around the oriented molecule portion and the melting speed with the surrounding polymer component is excessively large. Accordingly, while the high gloss is achieved, the uneven gloss is produced, or the end off-set is increased. On the other hand, if the endothermic peak is higher than 120° C., the higher gloss cannot be achieved.

Although the detail of the differential scanning calorimetry will be described later, the endothermic peak in the present invention is according to the amount of heat to be absorbed when the binder resin is once heated to 200° C. to be molten, and cooled to be solidified, and the temperature is raised again to melt the binder resin. Even in the second process of raising the temperature, the endothermic peak appears. This shows that the binder resin according to the present invention has high crystallinity, and the molecules are easily oriented. Because of such a resin, even if the resin is melt kneaded and formed into a toner, the resin can keep the endothermic peak as a resin contained in the toner.

The toner according to the present invention has the features described above, and in addition, it is important to control the viscoelastic characteristic of the toner.

In the viscoelastic characteristic of the toner measured at a frequency of 6.28 rad/sec, a storage elastic modulus at a temperature of 180° C. (G′180) is not less than 1.0×10² Pa but not more than 1.0×10⁴ Pa. Moreover, in a chart with a temperature on an x-axis and a loss tangent tan δ on a y-axis, tan δ has at least one peak having a peak top in the range of not less than 50° C. but not more than 70° C. Further, tan δ (P) at a peak top temperature that gives a peak top of the peak is not less than 2.0 but not more than 10.0, and the ratio of tan δ (P) to tan δ (Tm) at a softening temperature Tm of the toner (tan δ (P)/tan δ (Tm)) is not less than 2.5 but not more than 8.0.

The storage elastic modulus G′ of the toner represents the elastic term at the temperature.

In the case where using a fixing aid (an additive such as a low melting point wax and a crystalline polyester), the melting properties of the binder resin are controlled by the plastic effect, the viscosity is reduced in only part of the binder resin due to compatibility of the fixing aid with the binder resin. Then, the difference in the melting speed is produced between portions having reduced viscosity and other portions. As a result, the melting state becomes uneven, and the off-set portions partially appear.

On the other hand, in the binder resin used in the present invention, the crystalline state is formed within the molecule to control the melting speed of the whole binder resin. Thereby, the elastic state can be controlled uniformly. As a result, after the toner is molten, the toner has an optimal elasticity and achieves high gloss, and the end off-set is prevented.

The storage elastic modulus of the toner according to the present invention at a temperature of 180° C. (G′180) is not less than 1.0×10² Pa but not more than 1.0×10⁴ Pa. The storage elastic modulus (G′180) is more preferably not less than 3.0×10² Pa but not more than 8.0×10³ Pa, and particularly preferably not less than 5.0×10² Pa but not more than 5.0×10³ Pa.

A storage elastic modulus (G′180) less than 1.0×10² Pa indicates that the toner does not have sufficient elasticity, and the end off-set is increased. On the other hand, at a storage elastic modulus (G′180) more than 1.0×10⁴ Pa, the elasticity in the toner is excessively high, and a sufficient melting state cannot be formed. As a result, black spots may appear in a very small part of a fixed image.

The loss tangent tan δ is the ratio (G″/G′) of a loss elastic modulus (G″) to the storage elastic modulus (G′). Usually, the loss elastic modulus represents viscosity, and the storage elastic modulus represents elasticity. Namely, tan δ is an index indicating a balance between the viscosity and elasticity: the viscosity is high when tan δ is large, and conversely, the elasticity is high when tan δ is small.

Moreover, the peak top temperature in tan δ is equivalent to a temperature at which the binder resin in the toner is transited from a glass state to a thermally deformable state, and suggests that the micro-Brownian motion of the chains of molecules that form the binder resin is activated at the temperature. Accordingly, the peak temperature is also a temperature at which the toner starts to contribute to the melting properties such as gloss. At a peak temperature less than 50° C., the toner is softened, and the end off-set is easily produced. Conversely, at a peak temperature more than 70° C., the higher gloss is inhibited.

Accordingly, tan δ (P) at the peak top temperature specifies the states of the viscosity and elasticity when the micro-Brownian motion of the chains of the molecules is activated. Accordingly, tan δ (P) of not less than 2.0 indicates that the viscosity is higher when the micro-Brownian motion starts, and that the binder resin is easily flowed and deformed without an external force applied. As a result, the melting speed in the fixing temperature region is accelerated.

Tan δ (P) less than 2.0 indicates a large influence of the elasticity, and difficulty in drastically reducing the viscosity in the fixing temperature range. As a result, the higher gloss is inhibited. On the other hand, at tan δ (P) more than 10.0, the resin is already softened considerably in the region of a low temperature, and the end off-set is increased.

Further, the ratio of tan δ (P) above to tan δ (Tm) at the softening point Tm which is the temperature at which the toner is molten (tan δ (P)/tan δ (Tm)) is not less than 2.5 but not more than 8.0, and more preferably not less than 3.0 but not more than 5.0.

The ratio of not less than 2.5 indicates that as the absolute value, tan δ (P) is large and tan δ (Tm) is small. Namely, it indicates a strong influence of the viscous component in the vicinity of the peak temperature, and a strong influence of the elastic component in the vicinity of the softening point.

Accordingly, the ratio indicates the state where melting is accelerated around the oriented molecule portion in the vicinity of the peak temperature, and the state where the resin has the elasticity to some extent in the vicinity of the softening point, i.e., when the toner is molten. Accordingly, a ratio less than 2.5 or more than 8.0 indicates that control of the melting speed and the elastic state after melting are not balanced, resulting in the uneven gloss.

In order to achieve the physical properties above, in the toner according to the present invention, the softening point Tm of the toner needs to be not less than 90° C. but not more than 140° C.

At a softening point less than 90° C., the viscosity of the toner is excessively reduced to increase the end off-set. At a softening point more than 140° C., the higher gloss is inhibited.

As described above, some of the polymers within the molecule is partially oriented to form a crystalline state or a state close to crystal in the binder resin, and the viscoelastic characteristic of the toner using the binder resin is controlled in a predetermined range. Thereby, a toner that can provide an image with uniform and high gloss and prevent the end off-set can be obtained.

The endothermic peak and amount of heat to be absorbed in the DSC curve of the binder resin in the present invention are measured by the following method.

The peak temperature of the endothermic peak of the binder resin is measured according to ASTM D3418-82 using a differential scanning calorimeter “Q1000” (made by TA Instruments, Inc.).

The melting points of indium and zinc are used for temperature correction of the detecting unit in the apparatus, and heat of fusion of indium is used for correction of the amount of heat. Specifically, approximately 5 mg of the binder resin is precisely weighed, and placed in an aluminum pan. Using an empty aluminum pan as a reference, measurement is performed at a measurement temperature from 30° C. to 200° C. at a temperature raising rate of 10° C./min. In the measurement, the temperature is once raised to 200° C., and subsequently lowered to 30° C. at a temperature lowering rate of 10° C./min. Then, again, the temperature is raised at a temperature raising rate of 10° C./min. In this temperature raising process, change of specific heat is obtained. A point of intersection of a line from a midpoint of the baseline before and after the specific heat changes and the DSC curve is defined as a glass transition temperature Tg of the binder resin.

The endothermic peak obtained at a temperature not less than the glass transition temperature Tg in the range of temperature not less than 30° C. but not more than 200° C. in the second temperature raising process is defined as an endothermic peak in the present invention. The amount of heat to be absorbed ΔH of the endothermic peak can be obtained by determining an integral value of the region surrounded by the DSC curve and the baseline (endothermic peak).

Usually, the endothermic peak observed in the binder resin is a peak attributed to enthalpy relaxation or heat of fusion of the crystalline component.

The enthalpy relaxation is: if the temperature of an amorphous binder resin is raised, phase transition from a glass state to a super cooled liquid occurs at the glass transition temperature. The enthalpy relaxation is an endothermic peak attributed to expansion (relaxation) of the volume (enthalpy) in the phase transition. Presence/absence of the peak is influenced by the shape of the polymer chain of the binder resin. The binder resins having a linear polymer chain are likely to have the peak.

The heat of fusion of the crystalline component is thermal energy needed to cut interaction between molecules having the same orientation to produce a phase transition from a crystal (solid) state to a liquid state, as well known in crystalline polyesters and wax.

Namely, the endothermic peak in the DSC curve in the present invention indicates that the phase transition of the binder resin component occurs. It is thought that when the phase transition occurs, the molecular motion of the polymer chain of the binder resin is accelerated. Accordingly, the endothermic peak observed in the binder resin may be either of the peak concerning the enthalpy relaxation and the peak attributed to the heat of fusion of the crystalline component.

The viscoelastic characteristic of the toner in the present invention is measured by the following method.

As a measurement apparatus, a rotational flat disk type rheometer “ARES” (made by TA Instruments, Inc.) is used. As a sample for measurement, used is a sample obtained by pressure molding the toner into a disk shape having a diameter of 7.9 mm and a thickness of 2.0±0.3 mm under an environment of 25° C., using a tableting machine.

The sample is placed on a parallel plate. The temperature is raised from room temperature (25° C.) to 100° C. in 15 minutes, and the shape of the sample is arranged. Then, the temperature is cooled to a measurement starting temperature for measuring viscoelasticity, and the measurement is started. At this time, it is important to set the sample so that the initial normal force is 0. Moreover, as described below, in the subsequent measurement, the influence of the normal force can be cancelled by auto tension adjustment (Auto Tension Adjustment ON).

The measurement is performed on the following condition.

(1) A parallel plate having a diameter of 7.9 mm is used.
(2) The frequency (Frequency) is 6.28 rad/sec (1.0 Hz).
(3) The initial value of applied strain (Strain) is set at 0.1%.
(4) The measurement is performed in the range from 30° C. to 200° C. at a temperature raising rate (Ramp Rate) of 2.0° C./min. The measurement is performed on the setting condition of the auto adjustment mode below. The measurement is performed on the auto strain adjustment mode (Auto Strain).
(5) The maximum applied strain (Max Applied Strain) is set at 20.0%.
(6) The maximum torque (Max Allowed Torque) is set at 200.0 g·cm, and the minimum torque (Min Allowed Torque) is set at 0.2 g·cm.
(7) Strain adjustment (Strain Adjustment) is set at 20.0% of Current Strain. In the measurement, the auto tension adjustment mode (Auto Tension) is used.
(8) The auto tension direction (Auto Tension Direction) is set at compression (Compression).
(9) The initial static force (Initial Static Force) is set at 10.0 g, and the auto tension sensitivity (Auto Tension Sensitivity) is set at 40.0 g.
(10) As the operating condition of the auto tension (Auto Tension), the sample modulus (Sample Modulus) is not less than 1.0×10³ Pa.

The softening points of the toner and binder resin in the present invention are measured using a constant load extrusion type capillary rheometer “rheological properties evaluating apparatus Flowtester CFT-500D” (made by SHIMADZU Corporation) according to the manual attached to the apparatus by the following method.

In the apparatus, while a constant load is applied onto a sample for measurement from the top of the sample by a piston, the temperature of the sample for measurement filled into a cylinder is raised to melt the sample. The molten sample for measurement is extruded from a die at the bottom of the cylinder. A flow curve showing the relationship between the distance the piston travels down at this time and the temperature can be obtained.

In the present invention, a “melting temperature in the ½ method” according to the manual attached to the “rheological properties evaluating apparatus Flowtester CFT-500D” is defined as the softening point. The melting temperature in the ½ method is calculated as follows.

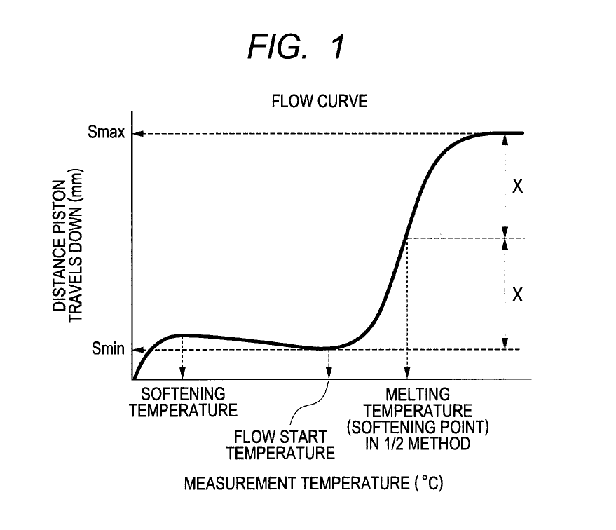

Hereinafter, using FIG. 1, the calculation will be described.

First, ½ of the difference between the distance the piston travels down Smax when the flow is completed and the distance the piston travels down Smin when the flow is started is determined (the value is defined as X. X=(Smax−Smin)/2).

Then, the temperature in the flow curve when the distance the piston travels down is the sum of X and Smin in the flow curve is the melting temperature in the ½ method.

As the sample for measurement, used is the one obtained by pressure molding approximately 1.0 g of a sample into a cylindrical shape having a diameter of approximately 8 mm under an environment of 25° C. at approximately 10 MPa for approximately 60 seconds using a tablet molding press machine (for example, NT-100H, made by NPa SYSTEM CO., LTD.).

The measurement condition of the CFT-500D is as follows.

Test mode: temperature raising method
Starting temperature: 30° C.
Target temperature: 200° C.
Interval of measurement: 1.0° C.
Temperature raising rate: 4.0° C./min
Area of the cross section of the piston: 1.000 cm²
Test load (load of the piston): 10.0 kgf (0.9807 MPa)
Preheating time: 300 seconds
Diameter of the opening of the die: 1.0 mm

### Length of the die: 1.0 mm

In order to obtain the viscosity of the toner above, in the toner according to the present invention, the peak molecular weight (Mp) measured by gel permeation chromatography (GPC) of the THF soluble matter preferably has at least one peak in a region of not less than 3000 but not more than 10000.

Further, in order to obtain the storage elastic modulus (G′) above, the toner contains preferably not less than 20% by mass but not more than 40% by mass, and more preferably not less than 25% by mass but not more than 35% by mass of the THF insoluble matter.

The glass transition temperature of the toner is preferably not less than 45 but not more than 60° C., and more preferably not less than 45 but not more than 58° C. from the viewpoint of the high gloss properties and the off-set resistance at a high temperature.

As the binder resin used in the present invention, from the viewpoint of orienting part of the molecules to provide crystallinity, polyester resins are preferable. Among them, particularly preferable are linear polyesters. The components of the linear polyester resin particularly preferably used in the present invention are as follows.

Examples of divalent acid components include dicarboxylic acids or derivatives thereof as follows: benzenedicarboxylic acids, anhydrides thereof, or lower alkyl esters thereof such as phthalic acid, terephthalic acid, isophthalic acid, and phthalic anhydride; alkyl dicarboxylic acids, anhydrides thereof, or lower alkyl esters thereof such as succinic acid, adipic acid, sebacic acid, and azelaic acid; alkenyl succinic acids or alkyl succinic acids, anhydrides thereof, or lower alkyl esters thereof such as n-dodecenylsuccinic acid and n-dodecylsuccinic acid; and unsaturated dicarboxylic acids, anhydrides thereof, or lower alkyl esters thereof such as fumaric acid, maleic acid, citraconic acid, and itaconic acid.

As the feature of the present invention, part of the molecular chain of the binder resin is oriented to provide crystallinity. For this reason, preferable are aromatic dicarboxylic acids because those have a strong flat structure including a large amount of electrons non-localized by the n electron system, thereby to easily orient the molecules by the π-π interaction. Particularly preferable are terephthalic acid and isophthalic acid easily having a linear structure. The content of the aromatic dicarboxylic acid is preferably not less than 50.0 mol % based on 100.0 mol % of the acid component that forms the polyester resin from the viewpoint of control of the temperature of the endothermic peak. The content is more preferably not less than 70.0 mol %, and particularly preferably not less than 80.0 mol %.

Examples of a divalent alcohol component include as follows: ethylene glycol, polyethylene glycol, 1,2-propanediol, 1,3-propanediol, propylene glycol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, bisphenols represented by the formula (1):

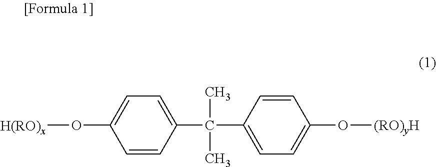

(wherein R is an ethylene or a propylene group, x and y each are an integer of not less than 0, and the average value of x+y is 0 to 10) and derivatives thereof, and diols represented by the formula (2):

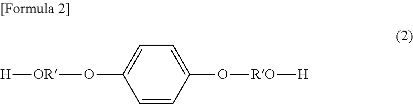

(wherein R′ represents —CH₂CH₂—, —CH₂—CH(CH₃)—, or —CH₂—C(CH₂)₂—.)

Among these, preferable are aliphatic alcohols having not more than 6 carbon atoms, which easily have a linear structure from the viewpoint of orienting part of the molecules to provide crystallinity. If only the alcohol is used, however, the crystallization degree is excessively high, and the amorphous property is lost. Accordingly, the crystal structure of the polyester resin obtained by the combination of the acid with the alcohol above needs to be partially broken. For this, particularly preferable is use of neopentyl glycol, 2-methyl-1,3-propanediol, 2-ethyl-1,3-hexanediol, and the like that have a linear structure and have a substituent in the side chain in which crystallinity can be sterically broken. These alcohol components are preferably not less than 20 mol % but not more than 50 mol %, and more preferably not less than 25 mol % but not more than 40 mol % based on the whole alcohol component.

Other than the divalent carboxylic acid compound and divalent alcohol compound above, the polyester resin used in the present invention may contain a monovalent carboxylic acid compound, a monovalent alcohol compound, a carboxylic acid compound having a valence of 3 or more, and an alcohol compound having a valence of 3 or more as the component.

Examples of the monovalent carboxylic acid compound include aromatic carboxylic acids having not more than 30 carbon atoms such as benzoic acid and p-methylbenzoic acid; and aliphatic carboxylic acids having not more than 30 carbon atoms such as stearic acid and behenic acid.

Examples of the monovalent alcohol compound include aromatic alcohols having not more than 30 carbon atoms such as benzyl alcohol; and aliphatic alcohols having not more than 30 carbon atoms such as lauryl alcohol, cetyl alcohol, stearyl alcohol, and behenyl alcohol.

The carboxylic acid compound having a valence of 3 or more is not particularly limited, and examples thereof include trimellitic acid, trimellitic anhydride, and pyromellitic acid.

Examples of the alcohol compound having a valence of 3 or more include trimethylolpropane, pentaerythritol, and glycerol.

The method for producing a polyester resin according to the present invention is not particularly limited, and a known method can be used. For example, the carboxylic acid compound and alcohol compound above are prepared together, and subjected to an esterification reaction or a transesterification reaction and a condensation reaction to be polymerized. Thus, a polyester resin is produced. In polymerization of the polyester resin, for example, a polymerization catalyst such as titanium tetrabutoxide, dibutyltin oxide, tin acetate, zinc acetate, tin disulfide, antimony trioxide, and germanium dioxide can be used. The polymerization temperature is not particularly limited, and the range of not less than 180° C. and not more than 290° C. is preferable.

As the binder resin, the resin above may be used alone. Preferably, two or more binder resins (binder resin A and binder resin B) having different softening points are mixed and used. The binder resin A has a softening point lower than that of the binder resin B. Accordingly, the binder resin A is written as a low softening point resin, and the binder resin B is written as a high softening point resin.

These two resin having different softening points, namely, the low softening point resin and the high softening point resin are preferably mixed in the mixing ratio of 50:50 to 20:80 in the mass ratio, and used.

Of the two, the low softening point resin is designed so that the molecular chain of the low softening point resin is partially oriented to provide crystallinity. Such a design is a more preferred embodiment. This is because the melting speed of the resin can be more accelerated because the peak temperature of the binder resin and the softening temperature of the low softening point resin exist in approximately the same temperature region. For this reason, the softening point TA of the low softening point resin is preferably not less than 70° C. but not more than 100° C., and more preferably not less than 75° C. but not more than 95° C.

Accordingly, the high softening point resin having a low melting speed plays a role to coat the low softening point resin to prevent the end off-set in the fixing temperature region.

Preferably, the softening point TB of the high softening point resin is not less than 120° C. but not more than 180° C., and preferably not less than 130° C. but not more than 150° C.

The high softening point resin used in the present invention is preferably a hybrid resin of a polyester unit chemically bonded to a vinyl copolymerization unit. This is because the polyester resin portion and the vinyl resin portion each having a different melt viscosity produce gradient of the viscosity within the high softening point resin to contribute uniformity of the gloss.

In the fixing temperature region, first, the low softening point resin having a high melting speed is molten. Subsequently, the polyester portion of the high softening point resin having a melting speed lower than that of the low softening point resin is molten. At this stage, the two having the same polyester composition are well mixed with each other to form a smooth fixing surface. In the case where the surface of the paper has depressions and projections, however, the depressions and projections may be reflected, and as a result, very slight depressions and projections may be also produced on the surface of the fixed toner, causing unevenness. In such a case, because the vinyl resin that is the high softening point resin having a lower melting speed exists, the vinyl resin is molten into the depressions with priority to increase the uniformity of the gloss.

Moreover, because the vinyl resin is chemically bonded to the polyester unit, the vinyl resin does not cause uneven fixing due to phase separation.

On the other hand, in the case where a single hybrid resin is used, the molecular chain of the polyester resin portion is partially oriented. Thereby, crystallinity can be provided.

The mixing ratio of the polyester unit to the vinyl copolymerization unit is preferably 50:50 to 90:10 in the mass ratio. If the content of the polyester unit is less than 50% by mass, the viscosity is not reduced quickly, and the high gloss properties are inhibited. If the content is more than 90% by mass, uneven gloss may be produced.

Examples of a vinyl monomer for producing the vinyl copolymerization unit used in the binder resin of the present invention include styrene monomers and acrylic acid monomers as follows. Examples of the styrene monomers include styrene and o-methylstyrene, and examples of the acrylic acid monomers include acrylic acid, methyl acrylate, and acrylic acid-n-butyl.

The vinyl copolymerization unit may be a resin produced by using a polymerization initiator. As the polymerization initiator, known polymerization initiators below are used. Examples of the polymerization initiator include 2,2′-azobisisobutyronitrile, 2,2′-azobis(4-methoxy-2,4-dimethylvaleronitrile), and 2,2′-azobis(2,4-dimethylvaleronitrile). From the viewpoint of efficiency, the proportion of these polymerization initiators to be used is preferably not less than 0.05 parts by mass but not more than 10 parts by mass based on 100 parts by mass of the monomer.

The hybrid resin more preferably used as the binder resin in the present invention is a resin in which the polyester unit and the vinyl copolymerization unit are chemically bonded directly or indirectly.

For this reason, polymerization is performed using a compound reactive with both the polyester resin monomer and the vinyl resin monomer (hereinafter, referred to as a “double-reactive compound”). Examples of the double-reactive compound include compounds of fumaric acid, acrylic acid, methacrylic acid, citraconic acid, maleic acid, and dimethyl fumarate in the polycondensed resin monomer and the addition polymerized resin monomer. Among these, preferably used are fumaric acid, acrylic acid, and methacrylic acid.

The amount of the double-reactive compound to be used is not less than 0.1% by mass but not more than 20.0% by mass, and preferably not less than 0.2% by mass but not more than 10.0% by mass based on the whole raw material monomer.

Preferably, the binder resin has the molecular weight distribution below in the molecular weight distribution measured by gel permeation chromatography (GPC) of the tetrahydrofuran (THF) soluble matter.

The peak molecular weight MpB of the high softening point resin used as the high softening point resin is preferably not less than 5,000 but not more than 20,000, and the weight-average molecular weight MwB is preferably not less than 10,000 but not more than 500,000. The peak molecular weight MpA of the low softening point resin used as the low softening point resin is preferably not less than 2,000 but not more than 10,000, and the weight-average molecular weight MwA is preferably not less than 4,000 but not more than 20,000.

From the viewpoint of giving elasticity to the toner and further improving material dispersibility, preferably, the high softening point resin contains not less than 10.0% by mass but not more than 60.0% by mass of a THF insoluble component and preferably not less than 20.0% by mass but not more than 50.0% by mass of the THF insoluble component.

Further, the amount of heat to be absorbed of the endothermic peak obtained in the DSC curve of the binder resin of the present invention is preferably not less than 0.30 J/g but not more than 2.00 J/g, and more preferably not less than 0.50 J/g but not more than 1.50 J/g in order to obtain uniform and desired gloss.

In the present invention, in order to give releasing properties to the toner, a mold release agent (wax) can be used when necessary.

As the wax, preferable are hydrocarbon waxes such as low molecular weight polyethylenes, low molecular weight polypropylenes, microcrystalline wax, and paraffin wax because of easy dispersion in the toner and high releasing properties. When necessary, a small amount of one or two or more waxes may be used in combination.

Specifically, examples of the wax include: VISCOL (registered trademark) 330-P, 550-P, 660-P, and TS-200 (Sanyo Chemical Industries, Ltd.), Hi-WAX 400P, 200P, 100P, 410P, 420P, 320P, 220P, 210P, and 110P (Mitsui Chemicals, Inc.), SASOL H1, H2, C80, C105, and C77 (Schumann Sasol), HNP-1, HNP-3, HNP-9, HNP-10, HNP-11, and HNP-12 (Nippon Seiro Co., Ltd.), UNILIN (registered trademark) 350, 425, 550, 700, and UNICID (registered trademark), UNICID (registered trademark) 350, 425, 550, and 700 (Toyo-Petrolite Co., Ltd.), japan wax, bees wax, rice wax, candelilla wax, and carnauba wax (available from CERARICA NODA Co., Ltd.).

The timing to add the wax may be the time of melt kneading during production of the toner, or the time of producing the binder resin. It is properly selected from the existing methods. These waxes may be used alone or in combination.

Preferably, the amount of the wax to be added is not less than 1 part by mass but not more than 20 parts by mass based on 100 parts by mass of the binder resin.

The toner according to the present invention may be either of a magnetic toner and non-magnetic toner. If a magnetic toner is used, the toner preferably contains a magnetic iron oxide. As the magnetic iron oxide, iron oxides such as magnetite, maghemite, and ferrite are used. Moreover, in order to improve micro dispersibility in the toner particles, magnetic iron oxide is preferably subjected to a treatment of applying a shear force to a slurry during production to disentangle the magnetic iron oxide once.

The amount of magnetic iron oxide to be contained in the toner in the present invention is preferably not less than 25% by mass but not more than 45% by mass, and more preferably not less than 30% by mass but not more than 45% by mass in the toner.

In these magnetic bodies, a magnetic property applied at 795.8 kA/m is a coercivity of not less than 1.6 kA/m but not more than 12.0 kA/m, and a saturation magnetization is not less than 50.0 Am²/kg but not more than 200.0 Am²/kg (preferably not less than 50.0 Am²/kg but not more than 100.0 Am²/kg). Further, a residual magnetization is preferably not less than 2.0 Am²/kg but not more than 20.0 Am²/kg.

The magnetic properties of magnetic iron oxide can be measured using a vibrating sample magnetometer, for example, a VSM P-1-10 (made by Toei Industry Co., Ltd.).

In the case where a non-magnetic toner is used, carbon black and one or two or more other conventionally known pigments and dyes can be used as a colorant.

The amount of the colorant is preferably not less than 0.1 parts by mass and not more than 60.0 parts by mass, and more preferably not less than 0.5 parts by mass but not more than 50.0 parts by mass based on 100.0 parts by mass of the resin component.

In the toner according to the present invention, a charge control agent can be used in order to stabilize the charging properties. Depending on the kind of the charge control agent and the physical properties of other toner particle forming material, usually, the toner particles preferably contain not less than 0.1 but not more than 10.0 parts by mass of the charge control agent based on 100.0 parts by mass of the binder resin.

As such a charge control agent, negative charge control agents for the toner and positive charge control agents for the toner are known. According to the kind and application of the toner, one or two or more of various charge control agents can be used.

As the negative charge control agent for the toner, effective are organic metal complexes and chelate compounds, for example. Examples of those include monoazo metal complexes; acetylacetone metal complexes; metal complexes or metal salts of aromatic hydroxycarboxylic acids or aromatic dicarboxylic acid. Other than these, examples of the negative charge control agent for the toner include aromatic monocarboxylic acids and aromatic polycarboxylic acids, metal salts thereof, and anhydrides thereof; and phenol derivatives of esters and bisphenols.

Examples of the positive charge control agent for the toner include nigrosine and modified products with fatty acid metallic salts; quaternary ammonium salts such as tributylbenzylammonium-1-hydroxy-4-naphthosulfonic acid salt and tetrabutylammonium tetrafluoroborate, onium salts such as phosphonium salts that are analogs thereof, and lake pigments thereof; triphenylmethane dyes and lake pigments thereof (as a laking agent, phosphorus tungstate, phosphorus molybdate, phosphorus tungsten molybdate, tannic acid, lauric acid, gallic acid, ferricyanic acid, and ferrocyan compounds); and metal salts of higher fatty acids. In the present invention, one of these can be used, or two or more of these can be used in combination. Among these, as the positive charge control agent for the toner, the charge control agents such as nigrosine compounds, triphenylmethane lake pigments, and quaternary ammonium salts are particularly preferably used.

Specific examples of the charge control agent to be used include Spilon Black TRH, T-77, T-95, and TN-105 (HODOGAYA CHEMICAL CO., LTD.), and BONTRON (registered trademark) S-34, S-44, E-84, and E-88 (ORIENT CHEMICAL INDUSTRIES CO., LTD.). Preferable examples of the positive charge control agent can include TP-302 and TP-415 (HODOGAYA CHEMICAL CO., LTD.), BONTRON (registered trademark) N-01, N-04, N-07, and P-51 (ORIENT CHEMICAL INDUSTRIES CO., LTD.), and Copy Blue PR (Clariant International Ltd.).

Moreover, a charge control resin of a copolymer of a vinyl monomer with 2-acrylamide-2-methylpropanesulfonic acid can be used, and can also be used in combination with the charge control agent above. The charging property of the toner according to the present invention may be either of positive and negative. Preferably, the toner has the negative charging property because the polyester resin itself as the preferable binder resin has a high negative charging property.

Moreover, in the toner according to the present invention, as an inorganic fine powder, a fluidity improver having a high ability to give fluidity to the surfaces of the toner particles can be used, in which the number average particle diameter of a primary particle is small and a BET specific surface area is not less than 50 m²/g but not more than 300 m²/g. Any fluidity improver can be used if the fluidity improver can be externally added to the toner particles to increase the fluidity after addition compared to that before addition. Examples of the fluidity improver include: fluorine resin powders such as vinylidene fluoride fine powder and polytetrafluoroethylene fine powder; finely powdered silicas such as wet silica and dry silica, and processed silica obtained by surface treating these silicas with a silane coupling agent, a titanium coupling agent, or silicone oil. A preferable fluidity improver is the fine powder produced by vapor-phase oxidation of silicon halides, which is referred to as dry silica or fumed silica. For example, the process uses a pyrolysis oxidation reaction of silicon tetrachloride gas in oxygen and hydrogen, and the reaction formula is:

SiCl₄+2H₂+O₂→SiO₂+4HCl

The preferable fluidity improver may be a composite fine powder of silica and other metal oxide obtained by using a metal halide such as aluminum chloride or titanium chloride in combination with a silicon halide in this production step. A silica fine powder having the average primary particle diameter preferably in the range of not less than 0.001 μm but not more than 2 μm and particularly preferably in the range of not less than 0.002 μm but not more than 0.2 μm is preferably used.

More preferably, a processed silica fine powder obtained by hydrophobization of the silica fine powder produced by vapor-phase oxidation of the silicon halide is used. Of the processed silica fine powders, a silica fine powder treated so that a degree of hydrophobization titrated by a methanol titration test designates a value in the range of not less than 30 but not more than 80 is particularly preferable.

As a method of hydrophobization, a chemical treatment is performed by an organic silicon compound that reacts with or physically adsorbs the silica fine powder. As a preferable method, the silica fine powder produced by the vapor-phase oxidation of a silicon halide is treated with an organic silicon compound. Examples of such an organic silicon compound include: hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilylmercaptan, trimethylsilylmercaptan, triorganosilyl acrylate, vinyldimethylacetoxysilane, dimethylethoxysilane, dimethyldimethoxysilane, diphenyldiethoxysilane, 1-hexamethyldisiloxane, 1,3-divinyltetramethyldisiloxane, 1,3-diphenyltetramethyldisiloxane, and dimethylpolysiloxane having 2 to 12 siloxane units per molecule and containing up to one hydroxyl group bonded to Si in each unit located at a terminal. One of these or a mixture of two or more thereof is used.

The silica fine powder may be treated with silicone oil, or may be treated in combination with the hydrophobization.

Preferably, a silicone oil having a viscosity at 25° C. of not less than 30 mm²/s but not more than 1000 mm²/s is used. For example, dimethyl silicone oil, methylphenyl silicone oil, α-methylstyrene-modified silicone oil, chlorophenyl silicone oil, and fluorine-modified silicone oil are particularly preferable.

Examples of a method for silicone oil treatment include: a method for directly mixing a silica fine powder treated with a silane coupling agent and a silicone oil by a mixer such as a Henschel mixer; a method for spraying a silicone oil to a silica fine powder as a base; and a method for dissolving or dispersing a silicone oil in a proper solvent, adding a silica fine powder to the solution, mixing the solution, and removing the solvent. In the silicone oil-treated silica, more preferably, after the treatment with the silicone oil, silica is heated in an inert gas at a temperature of not less than 200° C. (more preferably not less than 250° C.) to stabilize the coating of the surface.

Examples of a preferable silane coupling agent include hexamethyldisilazane (HMDS).

In the present invention, preferable are silicas treated by a method for treating silica with a coupling agent in advance and treating silica with a silicone oil, or a method for treating silica with a coupling agent and a silicone oil at the same time.

The amount of the inorganic fine powder to be used is preferably not less than 0.01 parts by mass but not more than 8.00 parts by mass, and more preferably not less than 0.10 parts by mass but not more than 4.00 parts by mass based on 100.00 parts by mass of the toner particles.

To the toner according to the present invention, other external additives may be added when necessary. Examples of the external additives include a charging aid, a conductivity agent, a fluidity agent, an anticaking agent, a mold release agent at the time of fixing by a heat roller, a lubricant, and resin fine particles and inorganic fine particles serving as a polishing agent.

Examples of the lubricant include polyfluoroethylene powder, zinc stearate powder, and polyvinylidene fluoride powder. Among them, preferable is polyvinylidene fluoride powder. Examples of the polishing agent include cerium oxide powder, silicon carbide powder, and strontium titanate powder. These external additives are sufficiently mixed with the toner particles using a mixer such as a Henschel mixer. Thereby, the toner according to the present invention can be obtained.

In production of the toner according to the present invention, the binder resin, the colorant, and other additives are sufficiently mixed by a mixer such as a Henschel mixer and a ball mill. The mixture is melt kneaded using a heat kneader such as a heat roll, a kneader, and an extruder. Subsequently, the kneaded product is cooled and solidified, followed by grinding and classification. Further, when necessary, the obtained product is sufficiently mixed with a desired additive by a mixer such as a Henschel mixer. Thus, the toner according to the present invention can be obtained.

The methods for measuring physical properties of the toner according to the present invention are as shown below. Examples described later are also measured according to the methods.

### <Measurement of THF Insoluble Matters in Binder Resin and Toner>

Approximately 1.0 g of the resin and the toner is weighed (W1 g), and placed into a cylindrical filter paper (for example, No. 86, R size of 28×100 mm, made by Advantec Toyo Kaisha, Ltd.). The filter paper is installed in a Soxhlet extractor, and extraction is performed for 16 hours using 200 ml of THF as a solvent.

At this time, extraction is performed at a reflux rate so that the extraction cycle of the solvent is once every approximately 4 minutes.

After the extraction is completed, the cylindrical filter paper is taken out, and vacuum dried at 40° C. for 8 hours. Then, the residue of the extraction is weighed (W2 g).

In the case of the toner, the weight of ash in the toner (W3 g) is determined according to the following procedure. Approximately 2 g of a sample is placed in a 30 ml magnetic crucible precisely weighed in advance, and the mass of the sample (Wa g) is precisely weighed. The crucible is put in an electric furnace and heated at approximately 900° C. for approximately 3 hours, and cooled in the electric furnace as it is. Under normal temperature, the crucible is cooled in a desiccator for not less than 1 hour as it is, and the mass of the crucible is precisely weighed. From this, the content of the ash (Wb g) is determined.

(Wb/Wa)×100=percentage of ash contained (% by mass)

From the percentage, the mass of the ash in the sample

(W3 g) is determined.

The THF insoluble matter in the toner is determined by the following expression:

THF insoluble matter in toner (%)=([W2−W3]/[W1−W3])×100

Moreover, in measurement of the THF insoluble matter in the binder resin, the THF insoluble matter is determined by the following expression:

THF insoluble matter (%)=(W2/W1)×100

In the case where a resin having high crystallinity is measured, part of the crystal component may be calculated as the THF insoluble matter.

### <Measurement of Molecular Weight Distribution by GPC>

A column is stabilized in a heat chamber at 40° C. THF is flowed into the column at this temperature as a solvent at a flow rate of 1 ml/min, and approximately 100 μl of a THF sample solution is injected. Thus, the measurement is performed. In measuring the molecular weight of the sample, the molecular weight distribution that the sample has is calculated from the relationship between the logarithmic value of the calibration curve created from several kinds of monodisperse polystyrene reference samples and the count value. As the standard polystyrene sample for creation of the calibration curve, for example, a standard polystyrene sample made by Tosoh Corporation or Showa Denko K. K. and having a molecular weight of approximately 10² to 10⁷ is used. A standard polystyrene sample having at least 10 points is preferably used. As a detector, an RI (refractive index) detector is used. The column may be a combination of a plurality of commercially available polystyrene gel columns. Examples thereof can include a combination of Shodex GPC KF-801, 802, 803, 804, 805, 806, 807, and 800P made by Showa Denko K. K., and a combination of TSKgel G1000H(H_{XL}), G2000H(H_{XL}), G3000H (H_{XL}), G4000H (H_{XL}), G5000H (H_{XL}), G6000H (H_{XL}), G7000H(H_{XL}), and a TSKgurd column made by Tosoh Corporation.

The sample is produced as follows.

A sample is put into THF, and left as it is at 25° C. for several hours. Then, by shaking, the sample is sufficiently mixed with THF (until coalescences of the sample disappear), and further left as it is for not less than 12 hours. At this time, the time to leave the sample in THF is for 24 hours. Subsequently, the mixture is passed through a sample processing filter (pore size of not less than 0.2 μm but not more than 0.5 μm, for example, a MAISHORI DISK H-25-2 (made by Tosoh Corporation) can be used), and the obtained product is used as the sample for GPC. The concentration of the sample is adjusted so that the resin component is not less than 0.5 mg/ml but not more than 5.0 mg/ml.

### <Method for Measuring Weight Average Particle Diameter (D4)>

The weight average particle diameter (D4) of the toner is determined as follows. Using a precise particle size distribution measuring apparatus “COULTER COUNTER Multisizer 3” (registered trademark, made by Beckman Coulter, Inc.) including an aperture tube of 100 μm according to a pore electric resistance method, and the dedicated software “Beckman Coulter Multisizer 3 Version 3.51” (made by Beckman Coulter, Inc.) attached to the COULTER COUNTER Multisizer 3 for setting the measurement condition and analyzing the measured data, the measurement is performed at 25,000 effective measuring channels. The measured data is analyzed. From the analyzed data, the weight average particle diameter (D4) is calculated.

As an electrolytic aqueous solution used for the measurement, those prepared by dissolving super grade sodium chloride in ion exchange water so that the concentration is approximately 1% by mass, for example, “ISOTON II” (made by Beckman Coulter, Inc.) can be used.

Before the measurement and analysis, the dedicated software is set up as follows.

On the “Change of Standard Measurement Method (SOM)” screen of the dedicated software, the total count number of the control mode is set at 50000 particles, the number of measurement is set at 1, and the Kd value is set at a value obtained using the “standard particle of 10.0 μm” (made by Beckman Coulter, Inc.). A threshold/noise level measurement button is pressed to automatically set the threshold and noise level. The current is set at 1600 pA, the gain is set at 2, and the electrolyte solution is set at the ISOTON II. Flush of the aperture tube after the measurement is checked.

On the “Setting Conversion from Pulse to Particle Diameter” screen of the dedicated software, the bin interval is set at the logarithm particle diameter, the particle diameter bin is set at the 256 particle diameter bin, and the particle diameter is set in the range of 2 μm to 60 μm.

A specific measurement method is as follows.

(1) Into a 250 ml round-bottom glass beaker dedicated to Multisizer 3, approximately 200 ml of the electrolytic aqueous solution is placed. The beaker is set on a sample stand, followed by stirring by a stirrer rod counterclockwise at 24 rpm/sec. Then, dirt and bubbles in the aperture tube are removed by the “flush of aperture” function of the analyzing software.
(2) Approximately 30 ml of the electrolytic aqueous solution is placed into a 100 ml flat-bottom glass beaker. Into this, as a dispersant, approximately 0.3 ml of a diluted solution is added, which is prepared by diluting “CONTAMINON N” (a 10% by mass aqueous solution of a neutral detergent with pH 7 for washing a precision measuring apparatus including a nonionic surface active agent, an anionic surface active agent, and an organic builder, made by Wako Pure Chemical Industries, Ltd.) 3 times by mass with ion exchange water.
(3) A predetermined amount of ion exchange water is placed into a water tank of an ultrasonic disperser “Ultrasonic Dispersion System Tetora 150” (made by Nikkaki-Bios Co., Ltd.) having an electric output of 120 W in which two oscillators with an oscillation frequency of 50 kHz are built-in in the state where a phase of one oscillator is shifted by 180° to that of the other. To the water tank, approximately 2 ml of the CONTAMINON N is added.
(4) The beaker in (2) is set in a fixing hole for the beaker in the ultrasonic disperser, and the ultrasonic disperser is operated. The height position of the beaker is adjusted so that the resonance state of the surface of the electrolytic aqueous solution in the beaker is the maximum.
(5) In the state where an ultrasonic wave is applied to the electrolytic aqueous solution in the beaker in (4), approximately 10 mg of the toner is added to the electrolytic aqueous solution little by little, and dispersed. Further, the ultrasonic dispersion is continued for 60 seconds. In the ultrasonic dispersion, the temperature of water in the water tank is properly adjusted so as to be not less than 10° C. but not more than 40° C.
(6) Using a pipette, the electrolyte aqueous solution in (5) having a dispersed toner is dropped into the round-bottom beaker in (1) disposed in the sample stand. The measurement concentration is adjusted so as to be approximately 5%. Then, the measurement is performed until the number of particles measured reaches 50000.
(7) The measured data is analyzed by the dedicated software attached to the apparatus, and the weight average particle diameter (D4) is calculated. The weight average particle diameter (D4) is the “average diameter” on the analysis/volume statistical value (arithmetic average) screen when graph/% by volume is set by the dedicated software.

### <Measurement of Magnetic Properties of Magnetic Iron Oxide Particle>

Using a vibrating sample magnetometer VSM-P7 made by Toei Industry Co., Ltd., the measurement was performed at a sample temperature of 25° C. and an external magnetic field of 795.8 kA/m.

### <Measurement of Average Primary Particle Diameter of Magnetic Iron Oxide Particle>

For obtaining the average primary particle diameter, using a scanning electron microscope (magnification of 40000 times), magnetic iron oxide particles are observed, the Feret diameters of 200 particles are measured, and the number average particle diameter is determined. In the present Examples, as a scanning electron microscope, S-4700 (made by Hitachi, Ltd.) was used.

### EXAMPLES

As above, the basic configuration and features of the present invention have been described. Hereinafter, the present invention will specifically be described according to Examples. However, embodiments of the present invention will not be limited by these.

### <Production Example of Binder Resin L-1>

Terephthalic acid: 100.0 mol parts
Ethylene glycol: 60.0 mol parts
Neopentyl glycol: 40.0 mol parts
The polyester monomer and an esterification catalyst (dibutyltin oxide) were placed into a 5 L autoclave. To the autoclave, a reflux cooler, a moisture separator, an N₂ gas introducing pipe, a thermometer, and a stirrer were attached. While N₂ gas was introduced into the autoclave, a polycondensation reaction was performed at 230° C. The reaction was performed while a degree of the progression of the reaction was monitored using viscosity. When the reaction progressed to the latter half, trimellitic anhydride: 5.0 mol parts was added. Thus, trimellitic anhydride is added in the latter half of the reaction. Thereby, the acid value can be adjusted without having an influence to the basic structure of polyester. After the reaction was completed, the produced resin was extracted from the container, cooled, and ground to obtain Binder Resin L-1. The physical properties of the resin are as shown in Table 2.

### <Production Examples of Binder Resins L-2 to L-9, H-6, H-8, and H-9>

A monomer shown in Table 1 and an esterification catalyst (dibutyltin oxide) were placed into a 5 L autoclave. To the autoclave, a reflux cooler, a moisture separator, an N₂ gas introducing pipe, a thermometer, and a stirrer were attached. While N₂ gas was introduced into the autoclave, a polycondensation reaction was performed at 230° C. The monomer “post added” shown in Table 1 was added in the latter half of the polycondensation reaction for adjustment of the acid value or hydroxyl value. After the reaction was completed, the produced resin was extracted from the container, cooled, and ground to obtain Binder Resins L-2 to L-9, H-6, H-8, and H-9. The physical properties of these resins are as shown in Table 2 and Table 3. In Table 1, the symbol C in long-chain diol represents the number of carbon atoms, and Mn represents the number average molecular weight. Mol part of long-chain diol is calculated wherein the value of Mn is the molecular weight.

### <Production Example of Binder Resin H-1>

Ethoxylated bisphenol A (2.2 mol of an adduct): 48.5 mol parts
Terephthalic acid: 34.5 mol parts
Adipic acid: 6.5 mol parts
Trimellitic anhydride: 5.0 mol parts
Fumaric acid: 1.5 mol parts
Acrylic acid: 4.0 mol parts
The polyester monomer was placed into a four-neck flask. To the flask, a pressure reducing apparatus, a moisture separator, a nitrogen gas introducing apparatus, a temperature measuring apparatus, and a stirrer were attached, and stirring was performed under a nitrogen atmosphere at 160° C. To the monomer, a mixture of a vinyl copolymerized monomer (styrene: 85.0 mol parts and 2-ethylhexyl acrylate: 15.0 mol parts) and 2.0 mol parts of benzoyl peroxide as a polymerization initiator was dropped from a dropping funnel over 4 hours. Subsequently, the reaction was made at 160° C. for 5 hours. Then, the temperature was raised to 230° C., 0.2% by mass of dibutyltin oxide was added, and the polycondensation reaction was performed for 6 hours.

After the reaction was completed, the produced resin was extracted from the container, cooled, and ground to obtain Binder Resin H-1. The physical properties of the resin are as shown in Table 3.

### <Production Example of Binder Resin H-2>

The same polyester monomer as that in the case of H-1 was placed into a four-neck flask. To the flask, a pressure reducing apparatus, a moisture separator, a nitrogen gas introducing apparatus, a temperature measuring apparatus, and a stirrer were attached, and stirring was performed under a nitrogen atmosphere at 160° C. To the monomer, a mixture of the same vinyl copolymerized monomer as that in the case of H-1 and 4.0 mol parts of benzoyl peroxide as a polymerization initiator was dropped from a dropping funnel over 4 hours. Subsequently, the reaction was made at 160° C. for 5 hours. Then, the temperature was raised to 230° C., 0.2% by mass of dibutyltin oxide was added, and the polycondensation reaction was performed for 4 hours.

After the reaction was completed, the produced resin was extracted from the container, cooled, and ground to obtain Binder Resin H-2. The physical properties of the resin are as shown in Table 3.

### <Production Example of Binder Resin H-3>

The same polyester monomer as that in the case of H-1 was placed into a four-neck flask. To the flask, a pressure reducing apparatus, a moisture separator, a nitrogen gas introducing apparatus, a temperature measuring apparatus, and a stirrer were attached, and stirring was performed under a nitrogen atmosphere at 160° C. To the monomer, a mixture of the same vinyl copolymerized monomer as that in the case of H-1 and 1.0 mol part of benzoyl peroxide as a polymerization initiator was dropped from a dropping funnel over 4 hours. Subsequently, the reaction was made at 160° C. for 5 hours. Then, the temperature was raised to 230° C., 0.2% by mass of dibutyltin oxide was added, and the polycondensation reaction was performed for 8 hours.

After the reaction was completed, the produced resin was extracted from the container, cooled, and ground to obtain Binder Resin H-3. The physical properties of the resin are as shown in Table 3.

### <Production Example of Binder Resin H-4>

Terephthalic acid: 80.0 mol parts
Trimellitic anhydride: 15.0 mol parts
Acrylic acid: 5.0 mol parts
1,6-Hexanediol: 60.0 mol parts
Neopentyl glycol: 40.0 mol parts
Binder Resin H-4 was obtained in the same manner as in the case of Binder Resin H-1 except that the polyester monomer above was used. The physical properties of the resin are as shown in Table 3.

### <Production Example of Binder Resin H-5>

Terephthalic acid: 80.0 mol parts
Trimellitic anhydride: 10.0 mol parts
Acrylic acid: 5.0 mol parts
Stearic acid: 5.0 mol parts
Ethylene glycol: 60.0 mol parts
Neopentyl glycol: 40.0 mol parts
Binder Resin H-5 was obtained in the same manner as in the case of Binder Resin H-1 except that the polyester monomer above was used. The physical properties of the resin are as shown in Table 3.

### <Production Example of Binder Resin H-7>

Styrene80.0 parts by mass
n-Butyl acrylate18.0 parts by mass
Methacrylic acid2.0 parts by mass
2,2-Bis(4,4-di-t-butylperoxycyclohexyl)propane2.4 parts by mass
While 200 parts by mass of xylene was stirred in a four-neck flask, replacement with nitrogen in the container was sufficiently performed, and the temperature was raised to 120° C. Subsequently, the respective components above were dropped over 4 hours. Further, after keeping them under a reflux of xylene for 10 hours, polymerization was completed. Under reduced pressure, the solvent was removed by distillation. Thus, Binder Resin H-7 was obtained. The physical properties of the resin are as shown in Table 3.

### <Production Example of Binder Resin H-10>

Neopentyl glycol: 36.0 mol parts
Ethylene glycol: 36.0 mol parts
1,4-Cyclohexanediol: 28.0 mol parts
Dimethyl terephthalate: 90.0 mol parts
Phthalic anhydride: 10.0 mol parts
The polyester monomer above and an esterification catalyst (dibutyltin oxide) were placed into a 5 L autoclave. To the autoclave, a reflux cooler, a moisture separator, an N₂ gas introducing pipe, a thermometer, and a stirrer were attached. While N₂ gas was introduced into the autoclave, a polycondensation reaction was performed at 230° C. After the reaction was completed, the produced resin was extracted from the container, cooled, and ground to obtain Polyester A.

A mixture of the obtained Polyester A: 80 mol parts, 1,4-butanediol: 10 mol parts, and dimethyl terephthalate: 10 mol parts, and an esterification catalyst (dibutyltin oxide) were subjected to the polycondensation reaction at 230° C. in the same manner as above. After the reaction was completed, the produced resin was extracted from the container, cooled, and ground to obtain Binder Resin H-10. The physical properties of the resin are as shown in Table 3.

### Example 1

Binder Resin L-130 parts by mass
Binder Resin H-170 parts by mass
Magnetic iron oxide particle 90 parts by mass (average particle diameter=0.20 μm, Hc=11.5 kA/m, δs=88 Am²/kg, δr=14 Am²/kg)
Commercially available low molecular polypropylene wax: VISCOL 660-P4 parts by mass
Charge control agent (T-77; made by HODOGAYA CHEMICAL CO., LTD.)₂ parts by mass
   The materials above were pre-mixed by a Henschel mixer, and melt kneaded by a biaxial kneading extruder. The obtained kneaded product was cooled, crushed by a hammer mill, and ground by a jet mill. The obtained ground powder was classified using a multi classifier using a Coanda effect to obtain magnetic toner particles having a weight average particle diameter (D4) of 7.2 μm and the negative charging property.

To 100 parts by mass of the magnetic toner particles, 1.0 part by mass of hydrophobic silica fine powder [BET specific surface area of 150 m²/g, obtained by hydrophobizing 100 parts by mass of silica fine powder with 30 parts by mass of hexamethyldisilazane (HMDS) and 10 parts by mass of dimethyl silicone oil] and 3.0 parts by mass of strontium titanate fine powder (D50: 1.0 μm) were externally added. The mixture was sieved out by a mesh having an opening of 150 μm to obtain Toner 1. The formula and obtained physical properties of the toner are shown in Table 4.

The machine used for evaluation in the present Example was a commercially available digital copier imagePress 1135 (made by Canon Inc.). In the evaluation machine, the toner was replaced by the toner produced in the present embodiment, and evaluation below was performed.

### <Evaluation of Gloss>

Using an Aurora Coat paper of 170 g/m² (made by Nippon Paper Industries Co., Ltd.), a solid image of nine 20-mm squares aligned in three columns and in three rows (amount of the toner to be disposed: 0.6 mg/cm²) was printed. The gloss of the image was measured by a handy gloss meter PG-3D (made by Tokyo Denshoku Co., Ltd.) on the condition of the angle of incidence of light of 75°, and the average gloss value of the nine squares was determined. It is determined that as a gloss value is higher, the surface of the image is smoother and the image is shinier with higher saturation. Conversely, if the gloss value is low, it is determined that the image is darker with lower saturation, and the surface of the image is rough. The result of evaluation is shown in Table 5.

A: gloss is not less than 20
B: gloss is not less than 17 but less than 20
C: gloss is not less than 15 but less than 17
D: gloss is not less than 12 but less than 15
E: gloss is less than 12

### <Evaluation of Uniformity of Gloss>

Using an Aurora Coat paper of 170 g/m² (made by Nippon Paper Industries Co., Ltd.), a solid image of nine 20-mm squares aligned in three columns and in three rows was printed on one sheet at an amount of the toner to be disposed of 0.3 mg/cm².

Next, the same image was printed on one sheet at an amount of the toner to be disposed of 0.4 mg/cm².

Thus, the amount of the toner to be disposed was adjusted from 0.3 to 0.8 mg/cm² in increments of 0.1 mg/cm², the image was printed on one sheet at each amount of the toner to be disposed, and six sheets in total were output.

The gloss of the respective images was measured using a handy gloss meter PG-3D (made by Tokyo Denshoku Co., Ltd.) on the condition of the angle of incidence of light of 75°, and the average gloss value of the nine squares was determined.

Based on the difference between the maximum value and minimum value of the gloss average value in the six sheets, the gloss uniformity was evaluated by the following criteria. The result of evaluation is shown in Table 5.

A: the difference between the maximum value and minimum value of the gloss of the plain paper is not more than 1
B: the difference between the maximum value and minimum value of the gloss of the plain paper is more than 2 and not more than 3
C: the difference between the maximum value and minimum value of the gloss of the plain paper is more than 3 and not more than 4
D: the difference between the maximum value and minimum value of the gloss of the plain paper is more than 4 and not more than 5
E: the difference between the maximum value and minimum value of the gloss of the plain paper is not less than 6

### <End Off-Set>

A fixing unit was dismounted from a commercially available digital copier imagePress 1135 (made by Canon Inc.). To the dismounted fixing unit, an external driving apparatus and a temperature control apparatus were attached. Modification was made so that the process speed was 665 mm/sec and the fixing nip width was 10 mm.

An image of a horizontal line pattern at a coverage rate of 2% was output on 100 sheets of an A5 size paper. Subsequently, a solid white image was output on one sheet of an A4 size paper. At this time, using the modified fixing unit, the fixing temperature was raised from 220° C. to 240° C. in increments of 5° C., and the image was output at each of the fixing temperatures. At each setting temperature, it was visually observed whether the toner was off-set on the ends of the solid white image on the A4 size paper.

The temperature at which the off-set was observed was defined as an end off-set producing temperature. The result of evaluation is shown in Table 5.

A: no end off-set at 240° C.
B: end off-set is produced at 240° C.
C: end off-set is produced at 235° C.
D: end off-set is produced at 230° C.
E: end off-set is produced at 225° C.
F: end off-set is produced at 220° C.

### <White Spots>

Under an environment of normal temperature and normal humidity (25° C., 60% RH), a solid black image was output on 100 sheets of an A4 size paper. The 100 sheets of images were all visually observed, and the number of white spots was counted. The result of evaluation is shown in Table 5.

A: no white spots are found.
B: of the 100 sheets of images, one white spot is found.
C: of the 100 sheets of images, two white spots are found.
D: of the 100 sheets of images, not less than three white spots are found.

In Example 1, a good result was obtained in all the evaluations above.

### Examples 2 to 9

Toners 2 to 9 were produced in the same manner as in Example 1 except that the kind of the binder resin and the ratio of the resin components in the formula shown in Table 4 were used. The physical properties of the toner are shown in Table 4.

Moreover, evaluation was performed in the same manner as above, and the result is shown in Table 5.

### Comparative Examples 1 to 5

Toners 10 to 14 were produced in the same manner as in Example 1 except that the kind of the binder resin and the ratio of the resin components in the formula shown in Table 4 were used. The physical properties of the toner are shown in Table 4. Moreover, evaluation was performed in the same manner as above, and the result is shown in Table 5.

TABLE 1

| Resin | | | | | | |
|---|---|---|---|---|---|---|
| No. | Composition of monomer (mol parts) | | | | | |
| L-1 | TPA (100.0) | EG (60.0) | NPG (40.0) | TMA (5.0) post added | — | — |
| L-2 | TPA (100.0) | EG (60.0) | NPG (40.0) | TMA (5.0) post added | — | Long-chain diol B (2.0) |
| L-3 | TPA (70.0) | FA (30.0) | 1,6-Hexanediol (80.0) | NPG(20.0) | — | Long-chain diol A (3.0) |
| L-4 | TPA (100.0) | BPAEO (50.0) | BPAPO (50.0) | — | — | — |
| L-5 | TPA (90.0) | FA (10.0) | EG (70.0) | 1,3-Propanediol(5.0) | NPG (25.0) | Long-chain diol C (3.0) |
| L-6 | AA (25.0) | FA (75.0) | 1,6-Hexanediol (100.0) | — | — | — |
| L-7 | TPA (30.0) | FA (70.0) | BPAPO (100.0) | — | — | — |
| L-8 | AA (25.0) | FA (75.0) | 1,6-Hexanediol (100.0) | — | — | — |
| L-9 | FA (100.0) | 1,6-Hexanediol (100.0) | — | — | — | — |
| H-6 | TPA (80.0) | TMA (20.0) | BPAPO (70.0) | EG(30.0) | — | — |
| H-8 | FA (100.0) | 1,4-Butanediol (82.0) | 1,6-Hexanediol (20.0) | — | — | — |
| H-9 | IFA (100.0) | 1,4-Butanediol (70.0) | 1,6-Hexanediol (30.0) | — | — | — |

TPA: Terephthalic acid
TMA: Trimellitic anhydride
FA: Fumaric acid
AA: Adipic acid
IFA: Isophthalic acid
EG: Ethylene glycol
NPG: Neopentyl glycol
BPA-PO: Bisphenol A propylene oxide adduct
BPA-EO: Bisphenol A ethylene oxide adduct
Long-chain diol A: C32, Mn420, Melting point 82° C.
Long-chain diol B: C54, Mn740, Melting point 109° C.
Long-chain diol C: C72, Mn1050, Melting point 121° C.

TABLE 2

| | Peak | | Amount of | | | |
|---|---|---|---|---|---|---|
| | tem- | | heat to be | | | THF |
| | per- | Softening | absorbed at | | | insoluble |
| Resin | ature | point TA | endothermic | MpA | MwA | matter (% |
| No. | (° C.) | (° C.) | peak (J/g) | (—) | (—) | by mass) |
| L-1 | 65 | 82 | 1.02 | 8000 | 9500 | 0 |
| L-2 | 109 | 82 | 1.05 | 6500 | 7000 | 0 |
| L-3 | 82 | 82 | 0.98 | 9500 | 11000 | 0 |
| L-4 | 60 | 72 | 0.50 | 5000 | 6500 | 0 |
| L-5 | 118 | 97 | 0.80 | 8000 | 8500 | 0 |
| L-6 | 53 | 60 | 0.21 | 750 | 1200 | 0 |
| L-7 | — | 96 | — | 5000 | 6000 | 0 |
| L-8 | 82 | 72 | 1.48 | 1500 | 2000 | 0 |
| L-9 | 92 | 94 | 3.61 | 1300 | 1800 | 0 |

TABLE 3

| | Peak | | Amount of | | | |
|---|---|---|---|---|---|---|
| | tem- | | heat to be | | | THF |
| | per- | Softening | absorbed at | | | insoluble |
| Resin | ature | point TB | endothermic | MpB | MwB | matter (% |
| No. | (° C.) | (° C.) | peak (J/g) | (—) | (—) | by mass) |
| H-1 | — | 140 | — | 8500 | 20000 | 40 |
| H-2 | — | 125 | — | 6000 | 18000 | 36 |
| H-3 | — | 151 | — | 12000 | 25000 | 51 |
| H-4 | 65 | 128 | 1.82 | 6500 | 15000 | 30 |
| H-5 | 118 | 128 | 1.06 | 6600 | 15000 | 30 |
| H-6 | — | 138 | — | 9000 | 21000 | 32 |
| H-7 | — | 145 | — | 12000 | 25000 | 52 |
| H-8 | 125 | 131 | 2.41 | 21000 | 50000 | 75 |
| H-9 | 115 | 125 | 8.10 | 18000 | 30000 | 60 |
| H-10 | 75 | 135 | 2.10 | 6000 | 8000 | 20 |

TABLE 4

| | | Low | High | | | | | | | | | | |
|---|---|---|---|---|---|---|---|---|---|---|---|---|---|
| | | softening | softening | | Endothermic | | | tanδ | | | THF | | |
| | | point | point | L/H | peak tem- | | | peak tem- | tanδ | tanδ(P)/ | insoluble | | |
| | Toner | resin No. | resin No. | ratio | perature | Tm | G′(180) | perature | (P) | tanδ(Tm) | matter (% | Mp | Tg |
| | No. | (L form) | (H form) | (—) | (° C.) | (° C.) | (Pa) | (° C.) | (—) | (—) | by mass) | (—) | (° C.) |
| Example 1 | 1 | L-1 | H-1 | 30/70 | 65 | 122 | 2.0 × 10³ | 65 | 3.0 | 4.0 | 28 | 8200 | 55 |
| Example 2 | 2 | L-3 | H-1 | 30/70 | 82 | 122 | 2.0 × 10³ | 65 | 3.1 | 4.8 | 28 | 8800 | 56 |
| Example 3 | 3 | L-2 | H-1 | 30/70 | 109 | 122 | 2.0 × 10³ | 65 | 3.0 | 3.1 | 28 | 7800 | 55 |
| Example 4 | 4 | L-4 | H-2 | 50/50 | 60 | 93 | 1.0 × 10² | 62 | 2.1 | 7.8 | 18 | 5500 | 54 |
| Example 5 | 5 | L-5 | H-3 | 20/80 | 118 | 138 | 9.0 × 10³ | 66 | 4.1 | 2.5 | 41 | 11000 | 58 |
| Example 6 | 6 | — | H-4 | 0/100 | 65 | 128 | 2.0 × 10³ | 65 | 2.1 | 2.6 | 30 | 6500 | 54 |
| Example 7 | 7 | — | H-5 | 0/100 | 118 | 128 | 2.0 × 10³ | 65 | 4.3 | 7.5 | 30 | 6600 | 54 |
| Example 8 | 8 | L-1 | H-6 | 30/70 | 100 | 122 | 4.0 × 10² | 58 | 2.7 | 5.2 | 22 | 8700 | 55 |
| Example 9 | 9 | L-1 | H-7 | 30/70 | 100 | 122 | 7.0 × 10³ | 68 | 3.3 | 2.7 | 36 | 11000 | 57 |
| Comparative | 10 | L-6 | H-6 | 30/70 | 53 | 120 | 9.0 × 10³ | 40 | 4.1 | 5.0 | 18 | 6000 | 54 |
| Example 1 | | | | | | | | | | | | | |
| Comparative | 11 | L-7 | H-8 | 30/70 | 125 | 128 | 9.0 × 10¹ | 90 | 2.2 | 2.2 | 65 | 14000 | 58 |
| Example 2 | | | | | | | | | | | | | |
| Comparative | 12 | L-8 | H-9 | 30/70 | 85/115 | 120 | 6.0 × 10¹ | 45 | 4.5 | 8.1 | 42 | 12000 | 54 |
| Example 3 | | | | | | | | | | | | | |
| Comparative | 13 | L-8 | | 100 | 75 | 120 | 7.0 × 10¹ | 48 | 4.0 | 7.6 | 18 | 6000 | 55 |
| Example 4 | | | | | | | | | | | | | |
| Comparative | 14 | L-9 | — | 100/0 | 90 | 91 | Mea- | 40 | 2.2 | 8.3 | 0 | 1300 | 47 |
| Example 5 | | | | | | | surement | | | | | | |
| | | | | | | | impossible | | | | | | |

TABLE 5

| | High | Gloss | End | White |
|---|---|---|---|---|
| | gloss | uniformity | off-set | spots |
| Example 1 | A | A | A | A |
| Example 2 | A | A | A | A |
| Example 3 | A | A | A | A |
| Example 4 | A | C | D | A |
| Example 5 | D | C | A | C |
| Example 6 | B | C | C | A |
| Example 7 | C | C | A | A |
| Example 8 | A | B | B | A |
| Example 9 | B | B | A | B |
| Comparative Example 1 | A | D | E | D |
| Comparative Example 2 | E | B | E | A |
| Comparative Example 3 | E | E | E | A |
| Comparative Example 4 | B | E | E | B |
| Comparative Example 5 | B | E | F | B |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-291641, filed Dec. 28, 2010, which is hereby incorporated by reference herein in its entirety.

1. A toner comprising toner particles, each of which contains a binder resin and a colorant, wherein
the binder resin comprises a resin having an endothermic peak at a temperature of not less than 55° C. but not more than 120° C. in a DSC curve measured by a differential scanning calorimeter,
a softening point Tm of the toner is not less than 90° C. but not more than 140° C., and wherein
in a viscoelastic characteristic of the toner measured at a frequency of 6.28 rad/sec,
i) a storage elastic modulus at a temperature of 180° C. (G′180) is not less than 1.0×10² Pa but not more than 1.0×10⁴ Pa,
ii) in a chart with a temperature on an x-axis and a loss tangent tan δ on a y-axis,
a) tan δ has at least one peak having a peak top in the temperature range of not less than 50° C. but not more than 70° C.,
b) tan δ (P) is not less than 2.0 but not more than 10.0 wherein a loss tangent at a peak top temperature that gives the peak top of the peak is tan δ (P), and
c) a ratio of tan δ (P) to tan δ (Tm) (tan δ (P)/tan δ (Tm)) is in the range of not less than 2.5 but not more than 8.0 wherein a loss tangent at a softening point Tm of the toner is tan δ (Tm).

2. The toner according to claim 1, wherein the binder resin has a binder resin (A) and a binder resin (B) each having a different softening point,
the binder resin (A) has a softening point TA (° C.), the binder resin (B) has a softening point TB (° C.),
the softening point TA (° C.) is lower than the softening point TB (° C.), and the softening point TA (° C.) is not less than 70° C. but not more than 100° C., and
the binder resin (A) has an endothermic peak at a temperature not less than 55° C. but not more than 120° C. in a DSC curve measured by a differential scanning calorimeter.

3. The toner according to claim 1, wherein the binder resin (B) is a hybrid resin of a polyester unit chemically bonded to a vinyl copolymerization unit.

4. The toner according to claim 2, wherein the binder resin (B) is a hybrid resin of a polyester unit chemically bonded to a vinyl copolymerization unit.
